(19) United States
(12) Patent Application Publication
(10) Pub. No.: US 2017/0092001 A1
(43) Pub. Date: Mar. 30, 2017

(54) AUGMENTED REALITY WITH OFF-SCREEN MOTION SENSING

(71) Applicant: Intel Corporation, Santa Clara, CA (US)

(72) Inventor: Glen J. Anderson, Beaverton, OR (US)

(21) Appl. No.: 14/866,337

(22) Filed: Sep. 25, 2015

(51) Int. Cl. G06T 19/00; G06F 3/16; G06T 7/00; G06F 3/01

(52) U.S. Cl. CPC G06T 19/006; G06F 3/016; G06F 3/16; G06T 7/004; G06T 2207/10016

(57) ABSTRACT

Systems, apparatuses and methods may provide for identifying a physical model of an object and determining a position of the physical model relative to a scene in a video. Additionally, if the position of the physical model is outside the scene, an effect may be generated, wherein the effect simulates an action by the object at the position outside the scene. In one example, the positioned is determined based on one or more of a first signal from the physical model, a second signal from a peripheral device or a third signal from a local sensor.

### TECHNICAL FIELD

Embodiments generally relate to augmented reality. More particularly, embodiments relate to augmented reality with off-screen motion sensing.

### BACKGROUND

Augmented reality (AR) applications may overlay video content with virtual and/or animated characters that interact with the environment shown in the video content. Such AR applications may be limited, however, to on-screen activity of the AR characters. Accordingly, the user experience may be suboptimal.

### BRIEF DESCRIPTION OF THE DRAWINGS

The various advantages of the embodiments will become apparent to one skilled in the art by reading the following specification and appended claims, and by referencing the following drawings, in which:

FIGS. 1A and 1B are illustrations of on-screen and off-screen activity, respectively, of an augmented reality object according to an embodiment;

FIGS. 2 and 3 are flowcharts of examples of methods of controlling augmented reality settings according to embodiments;

FIG. 4 is a block diagram of an example of an augmented reality architecture according to an embodiment;

FIG. 5 is a block diagram of an example of a processor according to an embodiment; and

FIG. 6 is a block diagram of an example of a computing system according to an embodiment.

### DESCRIPTION OF EMBODIMENTS

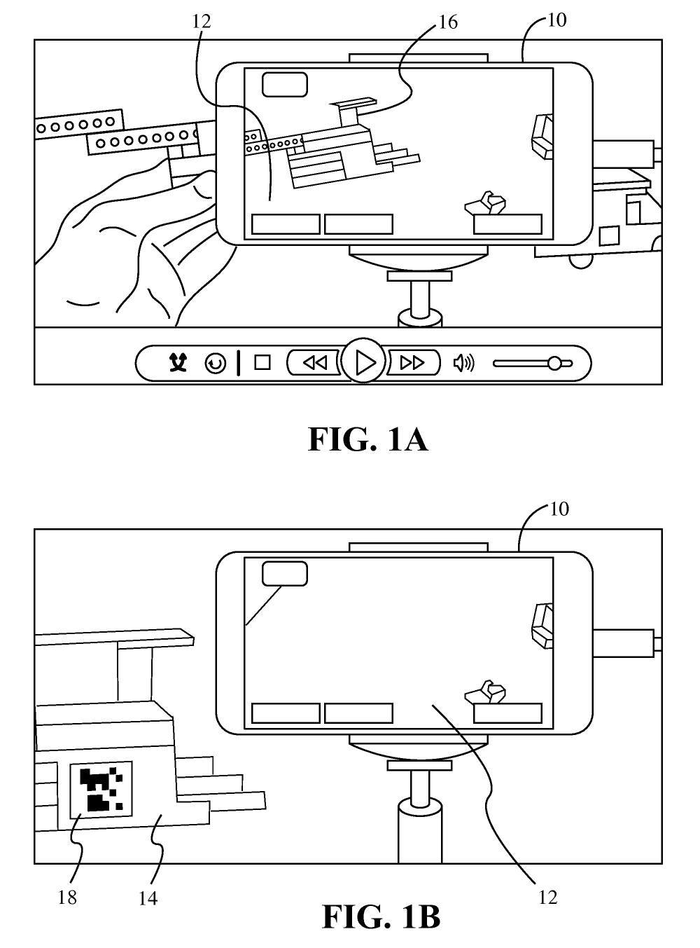

Turning now to FIGS. 1A and 1B, an augmented reality (AR) scenario is shown in which a reproduction system 10 (e.g., smart phone) records a scene behind the reproduction system 10 (e.g., using a rear-facing camera, not shown) and presents the recorded scene as an AR video on a front-facing display 12 of the system 10. The scene may include an actual scene and/or virtual scene (e.g., rendered against a “green screen”). As best shown in FIG. 1A, the AR video may be enhanced with on-screen virtual and/or animated content such as, for example, a virtual object 16 (e.g., toy helicopter), wherein the virtual object 16 corresponds to a physical model 14 (FIG. 1B) of the virtual object 16 being manipulated by a user. The physical model 14, which may be any item used to represent any object, may be identified based on a fiducial marker 18 (e.g., QR/quick response code, bar code) applied to a visible surface of the physical model 14, a radio frequency identifier (RFID) tag coupled to the physical model 14 and/or the result of object recognition techniques (e.g., using a local and/or remote camera feed).

FIG. 1B demonstrates that as the physical model 14 is moved to a position outside the scene being recorded, the system 10 may automatically remove the virtual object 16 from the AR video based on the new position of the physical model 14 may be generated. As will be discussed in greater detail, “off-screen” effects such as, for example, visual effects (e.g., smoke, crash debris, bullets, etc.) and/or sound effects (e.g., blade “whosh”, engine strain, crash noise) coming from the direction of the physical model 14. Additionally, the off-screen effects may include haptic effects such as vibratory representations of the physical model 14 drawing nearer to the field of view, olfactory effects such as burning smells, and so forth. Thus, the off-screen effects may generally simulate actions by objects at positions outside the scene. Modifying the AR video based on activity of the physical model 14 that takes place outside the scene represented in the AR video may significantly enhance the user experience. Although a single model 14 is shown to facilitate discussion, multiple different models 14 may be used, wherein their respective off-screen effects mix with one another.

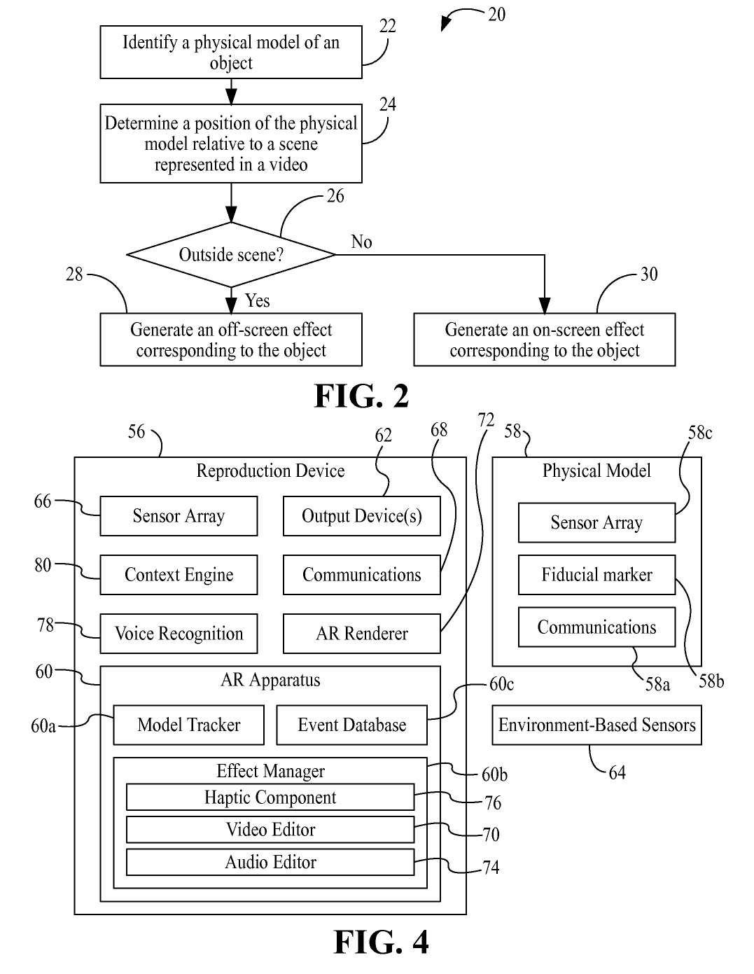

FIG. 2 shows a method 20 of controlling AR settings. The method 20 may be implemented as a module or related component in a set of logic instructions stored in a non-transitory machine- or computer-readable storage medium such as random access memory (RAM), read only memory (ROM), programmable ROM (PROM), firmware, flash memory, etc., in configurable logic such as, for example, programmable logic arrays (PLAs), field programmable gate arrays (FPGAs), complex programmable logic devices (CPLDs), in fixed-functionality hardware logic using circuit technology such as, for example, application specific integrated circuit (ASIC), complementary metal oxide semiconductor (CMOS) or transistor-transistor logic (TTL) technology, or any combination thereof. For example, computer program code to carry out operations shown in the method 20 may be written in any combination of one or more programming languages, including an object oriented programming language such as JAVA, SMALLTALK, C++ or the like and conventional procedural programming languages, such as the “C” programming language or similar programming languages. Other transitory media such as, for example, propagated waves, may also be used to implement the method 20.

Illustrated processing block 22 provides for identifying a physical model of an object. The physical model may be identified based on a local and/or remote camera feed using code scanning and/or object recognition techniques that facilitate detection of the physical model in the field of view of the camera(s) generating the feed. Illustrated block 24 determines a position of the physical model relative to a scene represented in a video. The position may be determined based on one or more signals from, for example, the physical model (e.g., sensor array coupled to the physical model), a peripheral device (e.g., environmental-based sensors), a local sensor (e.g., sensor array coupled to the reproduction device/system), etc., or any combination thereof.

A determination may be made at block 26 as to whether the position of the physical model is outside the scene represented (e.g., in real-time) in the video. If so, one or more off-screen effects corresponding to the object may be generated at block 28. The off-screen effects may simulate an action by the object (e.g., vehicle crashing, character speaker) at the position outside the scene. As already noted, generating the off-screen effect may include adding a visual effect to the video (e.g., overlaying smoke and/or debris at the edge of the screen adjacent to the physical object), adding a sound effect to audio associated with the video (e.g., inserting directional sound in the audio), triggering a haptic effect via a reproduction device associated with the video (e.g., vibrating the reproduction device to simulate a collision), and so forth.

The off-screen effect may be selected from an event database that associates object/physical model positions, states and/or conditions with various AR effects. Table I below shows one example of a portion of such an event database.

TABLE I

| Event | AR Effect |
|---|---|
| Powered on | Sound, e.g., of engine |
| Movement off of displayed scene | Doppler sound effect moving away |
| Crash to the right of the displayed | Light flash and smoke on right |
| scene | side of the screen |
| Crash off screen | Haptic vibration of reproduction |
| | device/system |

Additionally, the off-screen effect may be selected based on user input such as, for example, voice commands, gestures, gaze location, facial expressions, and so forth. Thus, block 28 might include recognizing a particular voice command, searching the event database for the voice command and using the search results to generate the off-screen effect. If, on the other hand it is determined at block 26 that the position of the physical model is not outside the scene represented in the video, illustrated block 30 generates one or more on-screen effects corresponding to the object (e.g., including displaying the object in the scene).

FIG. 3 shows a more detailed method 32 of controlling AR settings. Portions of the method 32 may be implemented as a module or related component in a set of logic instructions stored in a non-transitory machine- or computer-readable storage medium such as RAM, ROM, PROM, firmware, flash memory, etc., in configurable logic such as, for example, PLAs, FPGAs, CPLDs, in fixed-functionality hardware logic using circuit technology such as, for example, ASIC, CMOS or TTL technology, or any combination thereof.

In the illustrated example, a user activates video recording at block 34, which triggers an initiation of an AR subsystem at block 36. Additionally, the system may initiate object detection and tracking at block 38. In response to the user powering on the physical model at block 40, illustrated block 42 detects the presence of the model. The system may also detect at block 44 whether the model is in-frame (e.g., inside the scene represented in the video recording) or out-of-frame (e.g., outside the scene represented in the video recording). An optional block 46 may determine the position of the physical model relative to the recording/viewing (e.g., reproduction) device.

Illustrated block 48 determines one or more AF effects for the current presence, in-frame status and/or relative position of the physical model. Block 48 may therefore involve accessing an event database that associates object/physical model positions, states and/or conditions with various AR effects, as already discussed. In addition, the system may render the selected AR effects at block 50. The illustrated method 32 returns to block 44 if it is determined at block 52 that the presence of the physical model is still detected. Otherwise, the method 32 may terminate at block 54.

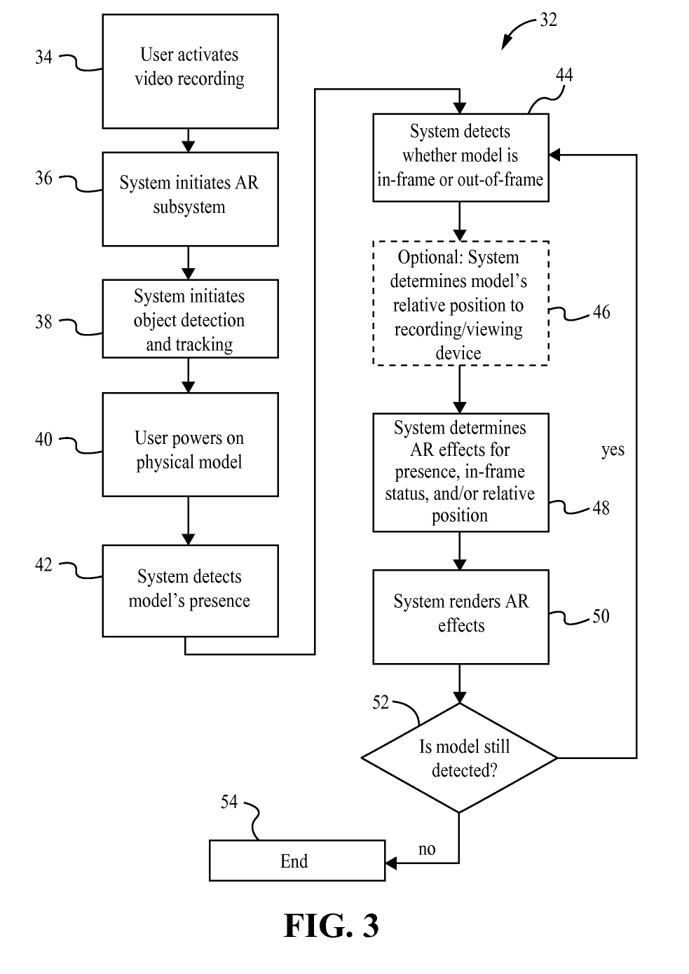

FIG. 4 shows an AR architecture in which a reproduction device 56 generally renders an AR video based on the position of a physical model 58 (58a-58c) of an object, wherein the components of the reproduction device 56 may be communicatively coupled to one another in order to accomplish the rendering. Accordingly, the reproduction device 56 may function similarly to the reproduction system 10 (FIGS. 1A and 1B) and the physical model 58 may function similarly to the physical model 14 (FIG. 1B), already discussed. Moreover, the reproduction device 56 and/or the physical model 58 may perform one or more aspects of the method 20 (FIG. 2) and/or the method 32 (FIG. 3), already discussed. In the illustrated example, the reproduction device 56 includes an AR apparatus 60 (60a-60c) having a model tracker 60a to identify the physical model 58 based on, for example, a fiducial marker 58b coupled to the physical model 58, an RFID tag coupled to the physical model 58, object recognition techniques, etc., or any combination thereof.

The model tracker 60a may also determine the position of the physical model 58 relative to a scene represented in a video presented via one or more output devices 62 (e.g., display, vibratory motor, air conducting speakers, bone conducting speakers, olfactory generator). The virtual position of the off-screen object may also be represented on the output device(s) 62. For example, stereo or surround sound speakers may enable the user perception of a directionality of the sound of the tracked object in the audio-video stream. In another example, a haptic motor may cause a vibration on the side of a viewing device that corresponds to the side of the tracked object.

The position may be determined based on, for example, signal(s) (e.g., wireless transmissions) from a communications module 58a and/or sensor array 58c (e.g., ultrasound, microphone, vibration sensor, visual sensor, three-dimensional/3D camera, tactile sensor, conductance meter, force sensor, proximity sensor, Reed switch, biometric sensor, etc.) of the physical model 58, signal(s) (e.g., wired or wireless transmissions) from a peripheral device including one or more environment-based sensors 64, signal(s) from a local sensor in a sensor array 66 (e.g., ultrasound, microphone, vibration sensor, visual sensor, 3D camera, tactile sensor, conductance meter, force sensor, proximity sensor, Reed switch, biometric sensor), etc., or any combination thereof. In one example, the reproduction device 56 uses a communications module 68 (e.g., having Bluetooth, near field communications/NFC, RFID capability, etc.) to interact with the environment-based sensors 64 and/or the communications module 58a of the physical model 58.

The illustrated AR apparatus 60 also includes an effect manager 60b to select effects to enhance the viewing experience. More particularly, the effect manager 60b may generate off-screen effects that simulate actions by the object at the position of the physical model if the position of the physical model is outside the scene being rendered (e.g., in real-time). As already noted, the effect manager 60b may also and generate on-screen effects corresponding to the object if the position of the physical model is within the scene being rendered (e.g., in real-time). For example, the effect manager 60b may search an event database 60c for one or more visual effects to be added to the video via a video editor 70, the output devices 62 and/or an AR renderer 72. Additionally, the effect manager 60b may search the event database 60c for one or more sound effects to be added to audio associated with the video via an audio editor 74, the output devices 62 and/or the AR renderer 72. Moreover, the effect manager 60b may search the event database 60c for one or more haptic effects to be triggered on the reproduction device 56 via a haptic component 76, the output devices 62 and/or the AR renderer 72. The haptic component 76 may generally cause the reproduction device 56 to vibrate. For example, the haptic component 76 may include a DC (direct current) motor rotatably attached to an off-center weight. Other haptic techniques may also be used. The effect manager 60b may also include other components such as, for example, olfactory components (not shown), and so forth. In one example, the effect manager 60b also initiates the proper timing of the AR experiences.

As already noted, the off-screen effect may be selected based on user input such as, for example, voice commands, gestures, gaze location, facial expressions, and so forth. In this regard, the reproduction device 56 may also include a voice recognition component 78 (e.g., middleware) to identify and recognize the voice commands, as well as a context engine 80 to determine/infer the current usage context of the reproduction device 56 based on the voice commands and/or other information such as one or more signals from the sensor array 66 (e.g., indicating motion, location, etc.). Thus, the selection of the off-screen effects (as well as on-screen effects), may take into consideration the outputs of the voice recognition component 78 and/or the context engine 80.

One or more of the components of the reproduction device 56 may alternatively reside in the physical model 58. For example, the physical model 58 might include an internal AR apparatus 60 that is able to determine the location of the physical model 58 as well as select the off-screen and/or on-screen effects to be used, wherein the reproduction device 56 may merely present the enhanced AR video/audio to the user.

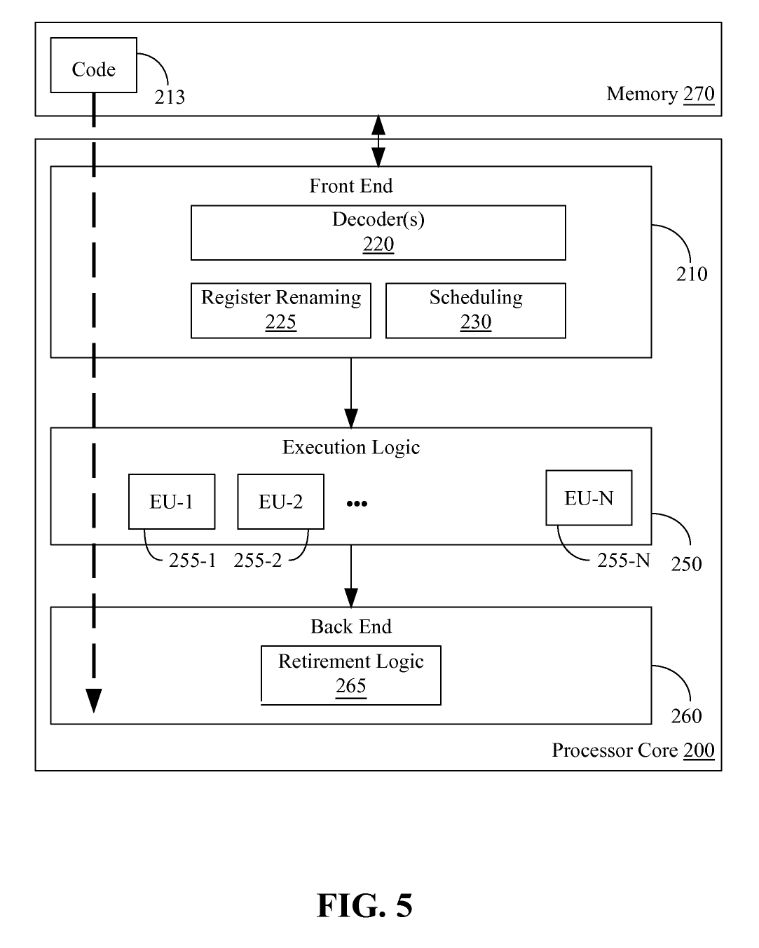

FIG. 5 illustrates a processor core 200 according to one embodiment. The processor core 200 may be the core for any type of processor, such as a micro-processor, an embedded processor, a digital signal processor (DSP), a network processor, or other device to execute code. Although only one processor core 200 is illustrated in FIG. 5, a processing element may alternatively include more than one of the processor core 200 illustrated in FIG. 5. The processor core 200 may be a single-threaded core or, for at least one embodiment, the processor core 200 may be multithreaded in that it may include more than one hardware thread context (or “logical processor”) per core.

FIG. 5 also illustrates a memory 270 coupled to the processor core 200. The memory 270 may be any of a wide variety of memories (including various layers of memory hierarchy) as are known or otherwise available to those of skill in the art. The memory 270 may include one or more code 213 instruction(s) to be executed by the processor core 200, wherein the code 213 may implement aspects of the method 20 (FIG. 2) and/or the method 32 (FIG. 3), already discussed. The processor core 200 follows a program sequence of instructions indicated by the code 213. Each instruction may enter a front end portion 210 and be processed by one or more decoders 220. The decoder 220 may generate as its output a micro operation such as a fixed width micro operation in a predefined format, or may generate other instructions, microinstructions, or control signals which reflect the original code instruction. The illustrated front end portion 210 also includes register renaming logic 225 and scheduling logic 230, which generally allocate resources and queue the operation corresponding to the convert instruction for execution.

The processor core 200 is shown including execution logic 250 having a set of execution units 255-1 through 255-N. Some embodiments may include a number of execution units dedicated to specific functions or sets of functions. Other embodiments may include only one execution unit or one execution unit that can perform a particular function. The illustrated execution logic 250 performs the operations specified by code instructions.

After completion of execution of the operations specified by the code instructions, back end logic 260 retires the instructions of the code 213. In one embodiment, the processor core 200 allows out of order execution but requires in order retirement of instructions. Retirement logic 265 may take a variety of forms as known to those of skill in the art (e.g., re-order buffers or the like). In this manner, the processor core 200 is transformed during execution of the code 213, at least in terms of the output generated by the decoder, the hardware registers and tables utilized by the register renaming logic 225, and any registers (not shown) modified by the execution logic 250.

Although not illustrated in FIG. 5, a processing element may include other elements on chip with the processor core 200. For example, a processing element may include memory control logic along with the processor core 200. The processing element may include I/O control logic and/or may include I/O control logic integrated with memory control logic. The processing element may also include one or more caches.

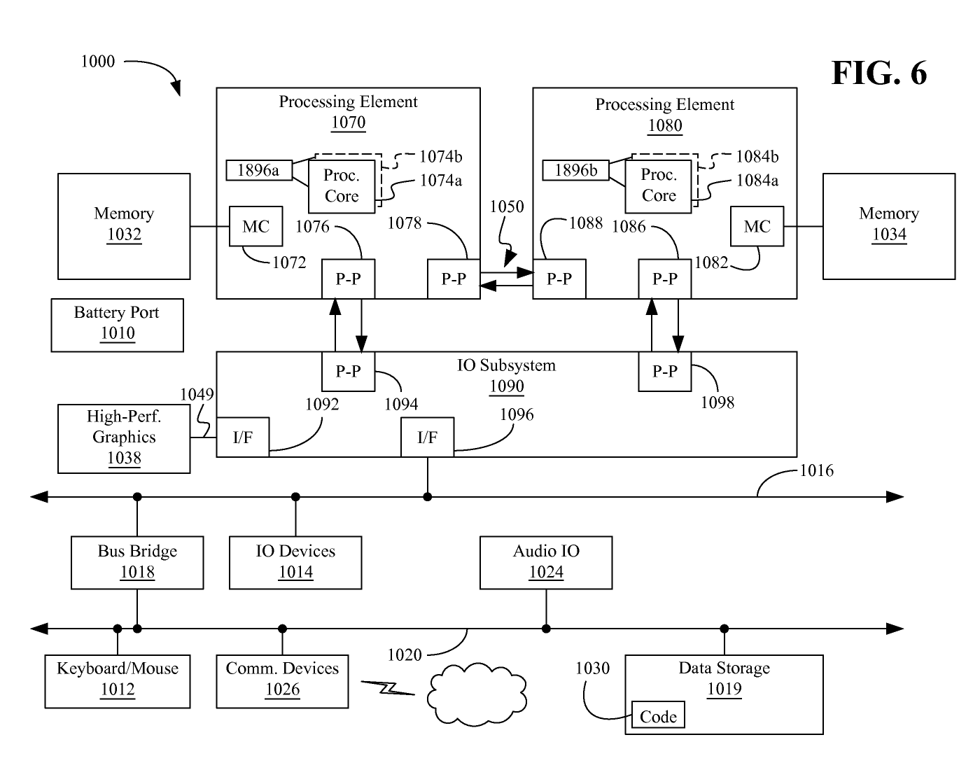

Referring now to FIG. 6, shown is a block diagram of a computing system 1000 embodiment in accordance with an embodiment. Shown in FIG. 6 is a multiprocessor system 1000 that includes a first processing element 1070 and a second processing element 1080. While two processing elements 1070 and 1080 are shown, it is to be understood that an embodiment of the system 1000 may also include only one such processing element.

The system 1000 is illustrated as a point-to-point interconnect system, wherein the first processing element 1070 and the second processing element 1080 are coupled via a point-to-point interconnect 1050. It should be understood that any or all of the interconnects illustrated in FIG. 6 may be implemented as a multi-drop bus rather than point-to-point interconnect.

As shown in FIG. 6, each of processing elements 1070 and 1080 may be multicore processors, including first and second processor cores (i.e., processor cores 1074a and 1074b and processor cores 1084a and 1084b). Such cores 1074a, 1074b, 1084a, 1084b may be configured to execute instruction code in a manner similar to that discussed above in connection with FIG. 5.

Each processing element 1070, 1080 may include at least one shared cache 1896a, 1896b. The shared cache 1896a, 1896b may store data (e.g., instructions) that are utilized by one or more components of the processor, such as the cores 1074a, 1074b and 1084a, 1084b, respectively. For example, the shared cache 1896a, 1896b may locally cache data stored in a memory 1032, 1034 for faster access by components of the processor. In one or more embodiments, the shared cache 1896a, 1896b may include one or more mid-level caches, such as level 2 (L2), level 3 (L3), level 4 (L4), or other levels of cache, a last level cache (LLC), and/or combinations thereof.

While shown with only two processing elements 1070, 1080, it is to be understood that the scope of the embodiments are not so limited. In other embodiments, one or more additional processing elements may be present in a given processor. Alternatively, one or more of processing elements 1070, 1080 may be an element other than a processor, such as an accelerator or a field programmable gate array. For example, additional processing element(s) may include additional processors(s) that are the same as a first processor 1070, additional processor(s) that are heterogeneous or asymmetric to processor a first processor 1070, accelerators (such as, e.g., graphics accelerators or digital signal processing (DSP) units), field programmable gate arrays, or any other processing element. There can be a variety of differences between the processing elements 1070, 1080 in terms of a spectrum of metrics of merit including architectural, micro architectural, thermal, power consumption characteristics, and the like. These differences may effectively manifest themselves as asymmetry and heterogeneity amongst the processing elements 1070, 1080. For at least one embodiment, the various processing elements 1070, 1080 may reside in the same die package.

The first processing element 1070 may further include memory controller logic (MC) 1072 and point-to-point (P-P) interfaces 1076 and 1078. Similarly, the second processing element 1080 may include a MC 1082 and P-P interfaces 1086 and 1088. As shown in FIG. 6, MC's 1072 and 1082 couple the processors to respective memories, namely a memory 1032 and a memory 1034, which may be portions of main memory locally attached to the respective processors. While the MC 1072 and 1082 is illustrated as integrated into the processing elements 1070, 1080, for alternative embodiments the MC logic may be discrete logic outside the processing elements 1070, 1080 rather than integrated therein.

The first processing element 1070 and the second processing element 1080 may be coupled to an I/O subsystem 1090 via P-P interconnects 1076 1086, respectively. As shown in FIG. 6, the I/O subsystem 1090 includes P-P interfaces 1094 and 1098. Furthermore, I/O subsystem 1090 includes an interface 1092 to couple I/O subsystem 1090 with a high performance graphics engine 1038. In one embodiment, bus 1049 may be used to couple the graphics engine 1038 to the I/O subsystem 1090. Alternately, a point-to-point interconnect may couple these components.

In turn, I/O subsystem 1090 may be coupled to a first bus 1016 via an interface 1096. In one embodiment, the first bus 1016 may be a Peripheral Component Interconnect (PCI) bus, or a bus such as a PCI Express bus or another third generation I/O interconnect bus, although the scope of the embodiments are not so limited.

As shown in FIG. 6, various I/O devices 1014 (e.g., speakers, cameras, sensors) may be coupled to the first bus 1016, along with a bus bridge 1018 which may couple the first bus 1016 to a second bus 1020. In one embodiment, the second bus 1020 may be a low pin count (LPC) bus. Various devices may be coupled to the second bus 1020 including, for example, a keyboard/mouse 1012, communication device(s) 1026, and a data storage unit 1019 such as a disk drive or other mass storage device which may include code 1030, in one embodiment. The illustrated code 1030 may implement the method 20 (FIG. 2) and/or the method 32 (FIG. 3), already discussed, and may be similar to the code 213 (FIG. 5), already discussed. Further, an audio I/O 1024 may be coupled to second bus 1020 and a battery port 1010 may receive power to supply the computing system 1000.

Note that other embodiments are contemplated. For example, instead of the point-to-point architecture of FIG. 6, a system may implement a multi-drop bus or another such communication topology. Also, the elements of FIG. 6 may alternatively be partitioned using more or fewer integrated chips than shown in FIG. 6.

### ADDITIONAL NOTES AND EXAMPLES

Example 1 may include a content reproduction system comprising a battery port, a display to present a video, a speaker to output audio associated with the video, and an augmented reality apparatus including a model tracker to identify a physical model of an object and determine a position of the physical model relative to a scene represented in the video and an effect manager communicatively coupled to the model tracker, the effect manager to generate, if the position of the physical model is outside the scene, an effect that simulates an action by the object at the position outside the scene.

Example 2 may include the system of Example 1, further including a local sensor, wherein the position is to be determined based on one or more of a first signal from the physical model, a second signal from a peripheral device or a third signal from the local sensor.

Example 3 may include the system of Example 1, wherein the effect manager includes a video editor to add a visual effect to the video.

Example 4 may include the system of Example 1, wherein the effect manager includes an audio editor to add a sound effect to audio associated with the video.

Example 5 may include the system of Example 1, wherein the effect manager includes a haptic component to trigger a haptic effect.

Example 6 may include the system of any one of Examples 1 to 5, wherein the effect manger is to select the effect from a database based on user input.

Example 7 may include an augmented reality apparatus comprising a model tracker to identify a physical model of an object and determine a position of the physical model relative to a scene represented in a video and an effect manager communicatively coupled to the model tracker, the effect manager to generate, if the position of the physical model is outside the scene, an effect that simulates an action by the object at the position outside the scene.

Example 8 may include the apparatus of Example 7, wherein the position is to be determined based on one or more of a first signal from the physical model, a second signal from a peripheral device or a third signal from a local sensor.

Example 9 may include the apparatus of Example 7, wherein the effect manager includes a video editor to add a visual effect to the video.

Example 10 may include the apparatus of Example 7, wherein the effect manager includes an audio editor to add a sound effect to audio associated with the video.

Example 11 may include the apparatus of Example 7, wherein the effect manager includes a haptic component to trigger a haptic effect via a reproduction device associated with the video.

Example 12 may include the apparatus of any one of Examples 7 to 11, wherein the effect manger is to select the effect from a database based on user input.

Example 13 may include a method of controlling augmented reality settings, comprising identifying a physical model of an object, determining a position of the physical model relative to a scene represented in a video, and generating, if the position of the physical model is outside the scene, an effect that simulates an action by the object at the position outside the scene.

Example 14 may include the method of Example 13, wherein the position is determined based on one or more of a first signal from the physical model, a second signal from a peripheral device or a third signal from a local sensor.

Example 15 may include the method of Example 13, wherein generating the off-screen effect includes adding a visual effect to the video.

Example 16 may include the method of Example 13, wherein generating the off-screen effect includes adding a sound effect to audio associated with the video.

Example 17 may include the method of Example 13, wherein generating the off-screen effect includes triggering a haptic effect via a reproduction device associated with the video.

Example 18 may include the method of any one of Examples 13 to 17, further including selecting the effect based on user input.

Example 19 may include at least one non-transitory computer readable storage medium comprising a set of instructions, which when executed by a computing device, cause the computing device to identify a physical model of an object, determine a position of the physical model relative to a scene represented in a video, and generate, if the position of the physical model is outside the scene, an effect that simulates an action by the object at the position outside the scene.

Example 20 may include the at least one computer readable storage medium of Example 19, wherein the position is to be determined based on one or more of a first signal from the physical model, a second signal from a peripheral device or a third signal from a local sensor.

Example 21 may include the at least one computer readable storage medium of Example 19, wherein the instructions, when executed, cause a computing device to add a visual effect to the video.

Example 22 may include the at least one computer readable storage medium of Example 19, wherein the instructions, when executed, cause a computing device to add a sound effect to audio associated with the video.

Example 23 may include the at least one computer readable storage medium of Example 19, wherein the instructions, when executed, cause a computing device to trigger a haptic effect via a reproduction device associated with the video.

Example 24 may include the at least one computer readable storage medium of any one of Examples 19 to 23, wherein the instructions, when executed, cause a computing device to select the effect from a database based on user input.

Example 25 may include an augmented reality apparatus comprising means for identifying a physical model of an object, means for determining a position of the physical model relative to a scene represented in a video, and means for generating, if the position of the physical model is outside the scene, an effect that simulates an action by the object at the position outside the scene.

Example 26 may include the apparatus of Example 25, wherein the position is to be determined based on one or more of a first signal from the physical model, a second signal from a peripheral device or a third signal from a local sensor.

Example 27 may include the apparatus of Example 25, wherein the means for generating the off-screen effect includes means for adding a visual effect to the video.

Example 28 may include the apparatus of Example 25, wherein the means for generating the off-screen effect includes means for adding a sound effect to audio associated with the video.

Example 29 may include the apparatus of Example 25, wherein the means for generating the off-screen effect includes means for triggering a haptic effect via a reproduction device associated with the video.

Example 30 may include the apparatus of any one of Examples 25 to 29, further including means for selecting the effect from a database based on user input.

Thus, techniques described herein may achieve model tracking in a variety of different ways depending on the circumstances. For example, the presence of a powered device (e.g., model) reporting its identifier (ID) may demonstrate that the model is in the vicinity of a radio (e.g., Bluetooth low energy/LE) in the reproduction device. Moreover, signal strength monitoring may also be used to track the physical model. In another example, the model might emit an ultrasonic signal that is detected by the reproduction device, wherein the ultrasonic signal may indicate distance and whether the model is moving closer or farther away. Additionally, environment-based sensors may be mounted on walls or other structures in order to map the location of the model to a 3D position in space. In yet another example, motion sensors in the model may enable the tracking of gestures (e.g., to change sound effects) even if the distance of the model from the reproduction device is unknown. Moreover, capacitive coupling may enable proximity tracking of models, particularly if the reproduction device is stationary. In such an example, as the user's hand and the model approach an electrostatically charged surface of the reproduction device, a sense of proximity may be estimated by the system.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the computing system within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A; B; C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. A system comprising:
a battery port;
a display to present a video; and
an augmented reality apparatus including,
a model tracker to identify a physical model of an object and determine a position of the physical model relative to a scene represented in the video, and
an effect manager coupled to the model tracker, the effect manager to generate, if the position of the physical model is outside the scene, an effect that simulates an action by the object at the position outside the scene.

2. The system of claim 1, further including a local sensor, wherein the position is to be determined based on one or more of a first signal from the physical model, a second signal from a peripheral device or a third signal from the local sensor.

3. The system of claim 1, wherein the effect manager includes a video editor to add a visual effect to the video.

4. The system of claim 1, wherein the effect manager includes an audio editor to add a sound effect from a database to audio associated with the video.

5. The system of claim 1, wherein the effect manager includes a haptic component to trigger a haptic effect.

6. The system of claim 1, wherein the effect manger is to select the effect based on user input.

7. An apparatus comprising:
a model tracker to identify a physical model of an object and determine a position of the physical model relative to a scene represented in a video; and
an effect manager coupled to the model tracker, the effect manager to generate, if the position of the physical model is outside the scene, an effect that simulates an action by the object at the position outside the scene.

8. The apparatus of claim 7, wherein the position is to be determined based on one or more of a first signal from the physical model, a second signal from a peripheral device or a third signal from a local sensor.

9. The apparatus of claim 7, wherein the effect manager includes a video editor to add a visual effect to the video.

10. The apparatus of claim 7, wherein the effect manager includes an audio editor to add a sound effect to audio associated with the video.

11. The apparatus of claim 7, wherein the effect manager includes a haptic component to trigger a haptic effect via a reproduction device associated with the video.

12. The apparatus of claim 7, wherein the effect manger is to select the effect from a database based on user input.

13. A method comprising:
identifying a physical model of an object;
determining a position of the physical model relative to a scene represented in a video; and
generating, if the position of the physical model is outside the scene, an effect that simulates an action by the object at the position outside the scene.

14. The method of claim 13, wherein the position is determined based on one or more of a first signal from the physical model, a second signal from a peripheral device or a third signal from a local sensor.

15. The method of claim 13, wherein generating the off-screen effect includes adding a visual effect to the video.

16. The method of claim 13, wherein generating the off-screen effect includes adding a sound effect to audio associated with the video.

17. The method of claim 13, wherein generating the off-screen effect includes triggering a haptic effect via a reproduction device associated with the video.

18. The method of claim 13, further including selecting the effect from a database based on user input.

19. At least one computer readable storage medium comprising a set of instructions, which when executed by a computing device, cause the computing device to:
identify a physical model of an object;
determine a position of the physical model relative to a scene represented in a video; and
generate, if the position of the physical model is outside the scene, an effect that simulates an action by the object at the position outside the scene.

20. The at least one computer readable storage medium of claim 19, wherein the position is to be determined based on one or more of a first signal from the physical model, a second signal from a peripheral device or a third signal from a local sensor.

21. The at least one computer readable storage medium of claim 19, wherein the instructions, when executed, cause a computing device to add a visual effect to the video.

22. The at least one computer readable storage medium of claim 19, wherein the instructions, when executed, cause a computing device to add a sound effect to audio associated with the video.

23. The at least one computer readable storage medium of claim 19, wherein the instructions, when executed, cause a computing device to trigger a haptic effect via a reproduction device associated with the video.

24. The at least one computer readable storage medium of claim 19, wherein the instructions, when executed, cause a computing device to select the effect from a database based on user input.
